(19) United States
(12) Patent Application Publication
(10) Pub. No.: US 2014/0353864 A1
(43) Pub. Date: Dec. 4, 2014

(54) SYSTEM, METHOD AND APPARATUS FOR CONTROLLING GROUND OR CONCRETE TEMPERATURE

(71) Applicant: Chester Grochoski, Spring Lake, MI (US)

(72) Inventor: Chester Grochoski, Spring Lake, MI (US)

(21) Appl. No.: 13/903,160

(22) Filed: May 28, 2013

(51) Int. Cl. C04B 41/00; B29C 35/00

(52) U.S. Cl. CPC C04B 41/0081; B29C 35/007; C04B 2111/00
USPC 264/40.6; 425/143

(57) ABSTRACT

A system, method and apparatus is described for achieving and maintaining concrete temperature during curing in order to improve the compressive strength of the finished concrete. A model to predict ambient conditions during a concrete pour is used to design an equipment layout scheme. A heating apparatus and a control system operate within the system to control concrete curing temperature. The system, method and apparatus are particularly useful for designing concrete pours of elevated slabs because the equipment layout is recommended based on the location of heat sinks such as I-beams, columns and rebar, etc. within a concrete slab. The system, method and apparatus are also useful for ground thawing projects.

### FIELD OF THE INVENTION

The present invention relates to concrete temperature control and ground thawing systems, models, methods and equipment.

### BACKGROUND OF THE INVENTION

Concrete cures during a period of time after it is poured into place, generally into forms, and develops a compressive strength based on several characteristics of the concrete and ambient conditions present during the pour and curing period. Usually, freshly mixed concrete arrives at a job site via a concrete mix truck and is discharged into formwork. A crew of workers spread the concrete so that it is more or less evenly distributed inside the forms. The next step is to strike off or “screed” the concrete so that it is level with the top of the forms and excess concrete is removed. Screeding must be completed before bleedwater appears on the surface of the concrete pour. The concrete is then “bull-floated” to press the aggregate, or stones, down below the surface of the concrete. Then an initial set must be reached before additional finishing of the concrete can occur. The initial set is complete about when a worker can stand on the concrete and leave only about ¼ inch deep indentation. Once the initial set is complete, troweling takes place. Troweling produces a dense, smooth finish. Highways, highway bridge decks and parking structures are typically “broomed” after troweling is complete to make the concrete slip resistant. Both troweling and brooming must be completed prior to the final set at which time the concrete has reached a level of stiffness which precludes further finishing. The time period between the initial set and the final set is known as the window of finishability. Once finished, the concrete may be sprayed with an evaporation retardant and covered with polyethylene sheeting.

One of the ambient conditions that will impact the amount of time concrete takes to reach its final set is temperature. When cold weather conditions are present, a longer period of time for concrete to set or cure is required. These conditions can lead to increased expense for a construction project because a finishing crew will be required to wait several hours between the pour and the initial set when finishing can be completed. Also, if concrete freezes before it reaches 500 PSI compressive strength, no amount of heat applied later will enable it to recover and reach design strength.

Several methods are known for keeping concrete from freezing or for thawing ground before construction can begin during winter conditions. Supplemental, or hydronic, heating hoses and/or insulating blankets may be placed on the concrete to keep it from freezing as it cures. One method involves placing conduit on the concrete or frozen ground and circulating a hot fluid, usually a blend of water and propylene glycol, through the conduit to transfer heat from the conduit to the concrete or frozen ground. Typically, these methods involve placing flexible hoses on top of the concrete or frozen ground in a back and forth manner, or in loops, from one end of the concrete or area of ground to the other end. Once the ground is thawed or the concrete cured, the hoses are removed. It is also known to embed these hoses in concrete to better distribute the heat. These hoses remain in the concrete once it is cured.

During ground thawing or concrete curing, it is desirable to have the area of ground or entire concrete pour at the same temperature. However, when heating a large area with circulating heat transfer fluid running through hoses, it is common for the fluid passing through a hose to be cooler at any point along its path as compared to the temperature of the fluid as it enters the hose. As the fluid flows through the hose, heat from the heat transfer fluid is transferred to the ground or concrete. Subsequently, the ground or concrete that is being warmed by the hose is warmed faster near the inlet end of the hose and the ground or concrete near the outlet end receives much less heat. The use of shorter hoses can decrease the time the fluid is in the hoses and can assist with, but does not resolve, diminished temperatures near the outlet of the hoses. Users of heating units for ground thawing or concrete curing may also rearrange the hoses after a time. However, this activity is time consuming and cumbersome with potentially thousands of feet of hoses to manage.

It is also known to reverse the direction of the flow of the heat transfer fluid in the hoses from time to time when a circulated system is used. Flow reversal of the heat transfer fluid in the hoses so that the hot fluid enters the outlet end of the hose and returns to the heater through the inlet end of the hose provide opportunity to even out the temperature gradient in the area to be warmed. However, this remedy does not fully address the causes of non-uniform thawing of ground or heating of concrete during curing.

### SUMMARY OF THE INVENTION

The present invention provides a fluid circulating apparatus for adjusting temperature of a material, comprising a fluid source having a supply line and a return line with a supply manifold in communication with said supply line and a return manifold in communication with said return line. A heat transfer hose is proposed with a first end and a second end. The first end is connected to the supply manifold, and the second end is connected to the return manifold. A controller determines a flow and a direction of fluid flow in the heat transfer hose, wherein the controller may control the flow by throttling at least one valve in the apparatus, and the controller may cause a pump in the apparatus to pause when said direction of fluid flow is changed.

A further embodiment provides an apparatus with a pressure relief conduit wherein said pressure relief conduit is in communication with both the supply line and the return line and allows a constant pressure to be maintained in the apparatus during throttling of the valve.

In another embodiment there is provided a fluid circulating apparatus for adjusting temperature of a material including a fluid source having a supply line and a return line, a supply manifold in communication with said supply line, and a return manifold in communication with said return line. A supply fluid chamber is in communication with the supply manifold and a return fluid chamber in communication with said return manifold while a heat transfer hose having a first end and a second end, said first end connected to said supply fluid chamber and said second end connected to said return fluid chamber. A controller determines a flow direction of the fluid in said heat transfer hose, wherein said direction may be in a forward or a reverse direction while fluid flow from said fluid source, through the supply line and the return line remains in a constant direction.

In further embodiments the apparatus includes a controller that adjusts a flow rate of the fluid by throttling at least one valve in the apparatus. Alternatively, the apparatus has a controller with a processor wherein said processor accepts temperature data from a plurality of temperature sensors in the material and the controller determines the flow direction and the flow rate of the fluid in the heat transfer hose based on the temperature data over a period of time.

Other aspects of the invention include a processor with a program to accept and store operating data. And the operating data includes at least one of an ambient air temperature, a wind speed, a fuel level remaining to run the apparatus, a heat transfer fluid temperature, a thermostat setting; a heat transfer fluid level, a verification that a generator is operational, and a verification that a plurality of systems are operational.

In another embodiment is a concrete strength optimizing system, comprising a concrete slab having structural characteristics wherein said characteristics vary within the slab, the slab having been placed during a concrete pour. A thermal profile is made of the structural characteristics wherein the thermal profile provides a prediction of temperature of said structural characteristics over a period of time relative to the pour. The concrete temperature is adjusted by an apparatus having an arrangement of components on the concrete slab wherein the arrangement is determined by a location of the structural characteristics and the prediction of temperature of structural characteristics over time to maintain a target temperature of the slab.

In another embodiment is a method for optimizing concrete strength development, the method comprising identifying an area of the concrete having a structural characteristic, providing a thermal prediction of the concrete in said area over a period of time subsequent to a pour of the concrete, determining a concrete target temperature for the concrete during curing, determining a type and quantity of heat transfer equipment required to maintain said concrete target temperature based on said thermal prediction. Once the concrete is poured, the method involves placing the heat transfer equipment on the concrete wherein a density of equipment is placed on the concrete according to the presence of the structural characteristic, monitoring a concrete temperature with a plurality of temperature sensors in the concrete, and adjusting said equipment to maintain said target temperature.

These and other features of the invention will be more fully understood and appreciated by reference to the description of the embodiments and the drawings.

### BRIEF DESCRIPTION OF THE DRAWINGS

FIG. 1 is a schematic representation of a thermal model.

FIG. 2 is schematic diagram of the steps involved in a model.

FIG. 3 is an example of a user interface input for Example Run 1.

FIG. 4 is an example of a thermal model result from Example Run 1.

FIG. 5 is an example of a user interface input for Example Run 2.

FIG. 6 is an example of a user interface input for Example Run 3.

FIG. 7 is an example of equipment layout results from Example Run 4.

FIG. 8 is an example of an equipment layout including concrete temperature sensor location.

FIG. 9 is a perspective view of a fluid manifold for use with the system, method and apparatus described herein.

FIG. 10 is a perspective view of a fluid manifold including pressure relief plumbing.

FIG. 11 is a perspective view of a fluid manifold for use with the system, method and apparatus described herein.

FIG. 12 is a side view of a stalk of temperature sensors with a concrete slab.

FIG. 13 is an alternate arrangement of temperature sensors.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DESCRIPTION OF THE CURRENT EMBODIMENTS

The system for curing concrete that may optimize concrete strength according to an embodiment of the invention includes a thermal model, an apparatus for transferring heat to curing concrete with components arranged according to a thermal profile predicted by the model and an apparatus control system, or controller, to maintain temperature parameters of concrete as it cures.

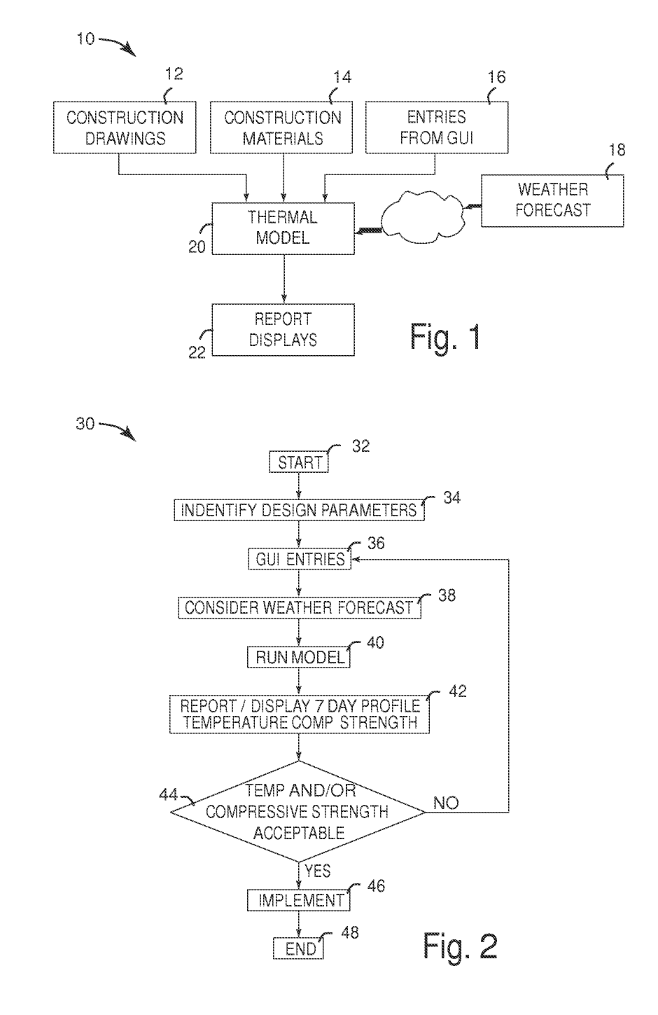

FIG. 1 is a schematic of a computer-based model 10 that can be used in the system. The model 10 may predict the temperature profile for a concrete slab during the curing process. By use of the model 10, Designers and Engineers may assess whether a concrete pour will require supplemental heat during the curing period to achieve design strength of the finished concrete. Model results and output such as reports and/or displays 22 are particularly useful for optimizing the resulting strength of concrete slabs that will be poured around or near large metal objects or heat sinks, such as I-beams in parking structures, bridge decks, and multi-story buildings, etc.

The embodiments described herein can be particularly useful for concrete construction projects using tilt-up walls or post-tensioned elevated slabs. Generally, the compressive strength of these types of concrete pours is confirmed to be within a range of the 28-day design strength, such as about 75%, prior to tilting up the walls or post-tensioning the slab. A contractor may also minimize the number of sets of forms required to complete a multi-floor project by forming and pouring a floor, efficiently curing the floor, post-tensioning the floor and then dismantling the forms. For projects involving multiple identical floors, the forms may then be placed on top of the slab that was just post-tensioned and the process repeated. Efficient utilization of forms and labor in this process may become important to a contractor's business as construction contracts frequently include bonus and/or penalty provisions based on time and/or costs for completion. Construction business owners and managers may find useful a cost/benefit analysis comparing use of the model and apparatuses described herein (possibly including rental or purchase of a heating apparatus) and potential turn-around time of a cold weather project (possibly adding many days) without thorough planning and provision of concrete heating.

To begin use of the model 10, a user provides detailed information about the construction site and concrete slab to be poured. Construction drawings 12 and details on materials 14 intended for use in the slab are provided and up loaded to a website, PC or similar system and can be identified and stored for later retrieval and analysis, if desired, by known methods currently known for saving, storing and retrieving information and files by electronic means. The user may be asked to enter details about the project via graphic user interface (“GUI”) 16 such as the expected date of the pour and design parameters such as concrete temperature target during curing or resulting compressive strength. The weather forecast 18 is recommended to be considered as it directly impacts ambient temperatures at the job site and, in turn, influences the concrete temperature during curing. Weather information for the forecast 18 may be obtained from a variety of sources depending upon whether the model 10 will be run within a few days of the concrete pour or within weeks. If the model is run within days of the pour, actual forecasts from a variety of news or weather sources or smart phone apps, etc. may be imported for use in the model 10. The user may desire to run the model 10 weeks or more in advance of the pour such that available weather forecasting sources and apps are not yet providing weather forecasts for the date of the pour. In that case, historical weather data may be presented to the user for the weather forecast 18 input for the model 10.

The GUI 16 will present design options to the user including, but not limited to, a target compressive strength for concrete slab and/or a target concrete temperature for the time period. Table 1 shows the relationship between compressive strength development and temperature at various times during the curing period.

TABLE 1
Type 1 Cement, Design Strength = 5,000 PSI @ 28 days 73° F.

| | Hours to | | Compressive Strength (PSI) | | | | | |
|---|---|---|---|---|---|---|---|---|
| Concrete | Initial | Final | ½ day | 1 day | 2 days | 3 days | 7 days | 28 days |
| Temp | Set | set | (12 hrs) | (24 hrs) | (48 hrs) | (72 hrs) | (168 hrs) | (672 hrs) |
| 120° F. | | | 1100 | 2100 | 2800 | 3000 | 3100 | 3800 |
| 105° F. | | | 1000 | 1900 | 2900 | 3400 | 3600 | 4100 |
| 90° F. | 4¼ | 5¾ | 800 | 1600 | 2500 | 3300 | 3800 | 4700 |
| 85° F. | 5 | 6½ | 700 | 1500 | 2400 | 3000 | 3800 | 4700 |
| 80° F. | 5½ | 7½ | 700 | 1400 | 2200 | 2900 | 3800 | 4800 |
| 73° F. | 6 | 9 | 600 | 1200 | 2000 | 2700 | 3700 | 5000 |
| 70° F. | 6 | 9 | 500 | 1100 | 1800 | 2500 | 3600 | 5000 |
| 60° F. | 8 | 11 | 100 | 800 | 1300 | 1900 | 3200 | 5100 |
| 55° F. | 8¼ | 13 | 100 | 600 | 1000 | 1600 | 3000 | 5100 |
| 50° F. | 8½ | 14 | 0 | 400 | 800 | 1300 | 2600 | 4800 |
| 40° F. | 14 | 19 | 0 | 100 | 300 | 800 | 1800 | 4100 |
| 30° F. | 19 | 25 | 0 | 0 | 200 | 500 | 1100 | 2200 |

| | |
|---|---|
| 20° F. | Concrete freezes and does not set |

As shown by the data in Table 1, strength development is compromised by curing concrete above 80° F. or below 50° F. The ideal curing temperature is 73° F. plus or minus 3° F. A contractor may confirm strength or readiness of the slab for post-tensioning, etc. by breaking test cylinders of concrete from each batch of concrete delivered to the job site. The data presented in the table suggests that cold weather concreting practices should be implemented if ambient air temperatures are likely to fall below 50° F. anytime during the first 7 days (168 hours) of placement. Although curing concrete at 55° F. is shown in Table 1 to yield 5100 PSI compressive strength at 28 days, early strength development is compromised and initial set and final set times are delayed to 8.25 and 13 hours, respectively. These delays may require having a finishing crew on site for up to 14 hours and can potentially result in exorbitant overtime costs.

With respect to Table 1 and concrete temperatures of between 20° F. and 30° F., the addition of chemical accelerators, such as non-chloride set accelerators, allow the placement and curing of concrete in this temperature range. Supplemental heating may be applied shortly after the pour to ensure concrete temperatures remain in a range conducive to strength development.

Once the user has entered the parameters, the model 10 will run and present results to the user. The user will have an opportunity to re-enter or change information through the GUI 16 to fine tune the results of the model 10, if desired. When the user is satisfied with the model 10 results, the user may request reports or request display of information useful in the remaining planning steps of the pour.

### Thermal Model

FIGS. 2-6 are representative of multiple runs of the thermal model 30. Referring first to FIG. 2, the user initiates or starts 32 the process by identifying or retrieving the project-specific drawings and details that were uploaded. The model 30 can identify, at step 34, the design features and/or structures relevant to the model 30. These features and/or structures may include, but are not limited to, the following details:

The engineering drawings of the concrete structure to be built (bridge, parking deck, etc.). Including but not limited to:

1. Details on the columns and support beams for the structure such as type of material, size and dimensions. These columns and supports are usually steel I-beams, box beams, precast concrete, etc.

2. Details related to the forms such as material (wood or stay-in-place steel for example)

3. Thickness of the slab to be poured. Typically, bridge decks vary in concrete thickness with the thinnest sections occurring along the outside edges and above the lightest duty support beams and columns.

4. Rebar sizes, material and location and/or post-tensioning cables and post-tensioning specifications.

5. Concrete mix formulation, including all ingredients such as cement type and amount, fine aggregate, coarse aggregate, water, admixture, if any, etc. Cement hydration is an exothermic chemical reaction, so a small amount of “free heat” is generated during the initial 40-48 hours after a pour. The thermal model 30 will take into account the “free heat” generated by the mix and incorporate it into the analysis.

The user will be prompted to provide additional information via GUI 36. The information requested from the user may include:

1. Selection of a target curing temperature and/or design strength of the concrete.

2. Selection of the seven day weather forecast 38 for the zip code of the construction project, including but not limited to daily high and low temperatures, precipitation, wind velocity and direction, cloud cover, and warm or cold fronts expected and at what day and time. This information is useful at predicting ambient job-site conditions for each of the 7 days (168 hours) of concrete curing.

3. The expected delivery temperature of the concrete.

4. Date and time of day for each concrete pour. Typically, a large construction project will require the concrete to be installed in areas of the construction site that have been subdivided into a number of more manageable areas. Dates and times planned for each pour to begin with the areas marked and/or numbered on the engineering drawings.

5. Equipment options for insulation or supplemental heating.

At step 40 in FIG. 2, the thermal model 30 calculates heat losses from complex shaped objects. For example, a portion of a concrete slab directly over a large I-beam support will lose heat, and its temperature will decrease, much more rapidly than a portion of the slab that is not near a large mass of cold steel. The thermal model 30 is capable of calculating the likely temperature of the concrete slab at one or many typical points on top of the slab, on the bottom and in between the top points and bottom points. The thermal model 30 is also capable of projecting the time to initial and final set. A display 42 or report of the results will be presented to the user. If the results do not yield an acceptable curing temperature prediction and/or concrete compressive strength development, the user may elect, through decision point 44, to return to the GUI entry 36 view and enter different selections. For example, the user may elect to run the model 30 with the assumption that insulation or supplemental heat will be used during the curing period. Several runs of the model 30 may be performed to provide options to the construction managers or designers. If the user is satisfied with the model 30 results or output, he or she may take steps to retrieve information for implementation 46 by requesting reports 22 (as in FIG. 1) etc. useful to implement 46 the project or capture displayed results to save or share. Once implementation information is obtained, the user may end the session 48. It should be understood that the computer based model 10, 30 may be accessed by a user of a personal computer provided the model software is installed on the personal computer having compatible processors and operating systems etc., by internet access to a website operated by an entity providing the services related to the model, or by smart phone application (“app”). The user may also provide information by email, or other delivery mechanism, the project's engineering drawings and associated specifications. An entity providing concrete heating and/or ground thawing services may find it preferable to host the model 10, 30 software on a server that is maintained by the entity. In that case, a user may connect to the server, via the Internet for example, and input the project data and request results. The entity maintaining the server may require and collect a fee from each user by any means known for conducting such transactions.

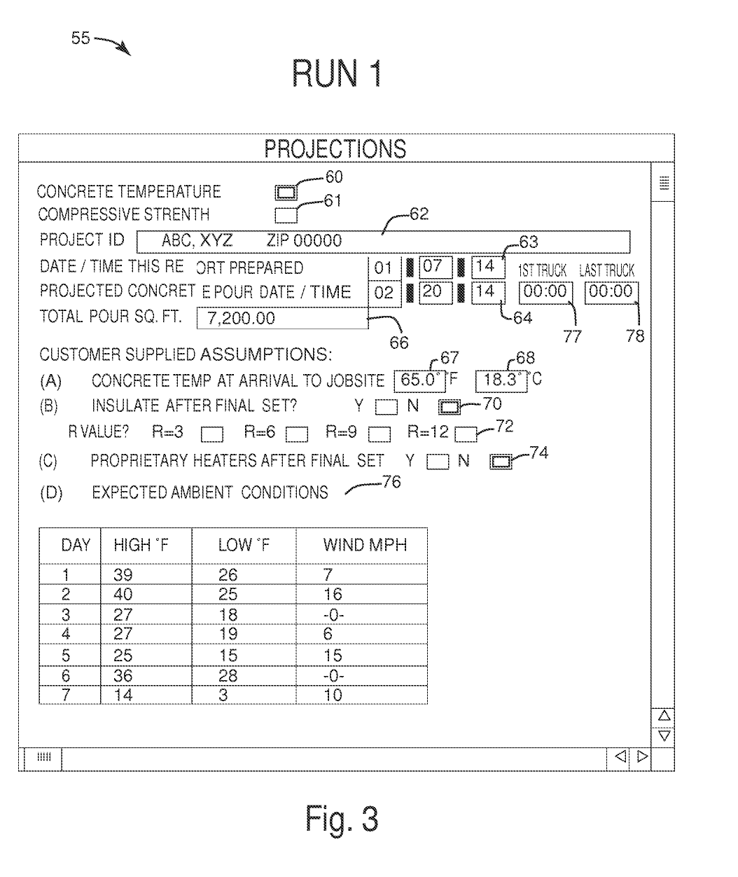

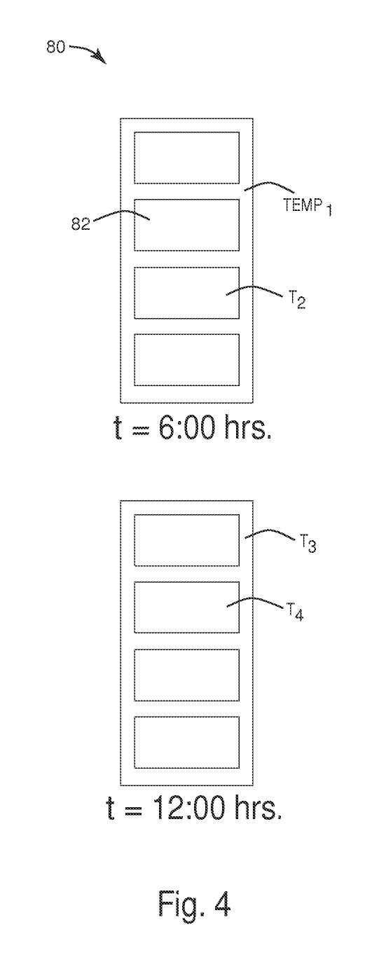

FIG. 3 is a representation of a GUI 55 that may be provided to assist a user in initiating the model 30 for example Run 1. The user may request multiple runs of the model as discussed below. For example, Run 1 shown in FIG. 3 relates to a bridge deck 60 feet by 120 feet and 6 inches thick. The total slab will require 7200 square feet of concrete times 6 inches or 3,600 cubic ft. (or about 133.33 cubic yards) of concrete. Typical mix trucks may deliver 8 cubic yards. The project will require 16.67 mix trucks. The construction manager may likely order 17 trucks at 8 cubic yards each to be delivered at a particular time interval, perhaps one truck every 20 minutes for 340 minutes of concrete placement time. The user may select design criteria such as projected, actual concrete temperatures 60 which will result during curing or compressive strength 61. In the example of FIG. 3, concrete temperature has been selected. The model 30 will result in temperature gradients being given over a period of curing time as discussed in more detail relative to FIG. 4. The project may be identified by input of this information at 62 including zip code if desired to aid in predication of ambient conditions. The date and time the report was prepared 63 may be entered or automatically populated upon start of the program associated with running the model 30. A projected or recommended time or time interval for the arrival of the first 77, 107 and/or last 78, 108 concrete delivery truck (or any number or delivery trucks in between) may be displayed by the GUI. The projected date of the pour 64 including date and/or time may be entered and is also useful in determining ambient conditions during the curing period. Information related to the total area 66 of the pour is especially useful when supplemental heating is planned so that operators of the system may plan to have the appropriate equipment on site.

Several parameters relative to the project may vary based on manager preferences. For example, temperature of the concrete upon delivery 67, 68, whether insulation is planned to be used during curing 70 and, if so, what type of insulation 72, and whether supplementary heat 74 is planned to be applied during curing. In the Run 1 example of FIG. 3, the user of the model 30 may request delivery of concrete at a particular delivery temperature 67, 68 and may input the expected delivery temperature for degrees Fahrenheit 67 or degrees Celsius 68. The GUI 55 may be designed to convert between U.S. customary (English) units and metric units. For example, degrees Fahrenheit may be converted to degrees Celsius or vice versa upon input of one the values, if desired. While the programming associated with the GUI may convert between metric and U.S. customary units, the programming may alternatively allow the user to enter data in either metric or U.S. customary units depending on the source documents available to the user and user preference. If the user enters metric units, the returned results will be in metric units. Likewise, if the user enters U.S. customary units, the results will be returned in U.S. customary units. For Run 1 a concrete delivery temperature of 65° F. or 18.3° C. is planned. Further for Run 1, the user has indicated that no insulation 70 or supplemental heating 74 is planned.

Once the information is entered in GUI 55, expected ambient conditions 76 are shown based on the date/time and location information entered. In the event the model 30 will be initiated in advance of reasonably reliable weather forecasts, the model 30 may provide historic data for the project location over a period of years. This historic data for the date indicated as a pour date, in our example February 20^{th}, and the six days subsequent to the pour date. For example, decades of historic data for February 21-26 would also be given for a total of seven days of historical weather data. Typically, ten to twenty years of historic data may be provided. The user may wish to make assumptions about the ambient temperature or conditions at the project location on the date of the pour, or may desire an opportunity to review and adjust the predicted ambient conditions due to specific information about the site conditions, or for other reasons, the user may do so at the GUI 55. Also, the user may request the model 30 to provide suggestions for adjusting the ambient conditions prediction. In that case, the model 30 may provide these and/or other suggestions: a calculation of the arithmetic mean, a calculation of the average after non-consideration of the two warmest and two coldest years, or select coldest year, etc. Once the user is satisfied, the model may be initiated to run.

After successful initiation of the computer-based model 30, the model will return concrete temperature results 80 as shown in the Run 1 example of FIG. 4. For this example, FIG. 4 includes temperature information (Temp. or T) for designated areas of the concrete pour at 6 hours (t=6:00 hrs) and 12 hours (t=12:00 hrs) post pour. However, the results may be represented as several diagrams, miniature plan views, or other representations of the project for any interval of time from the time of the pour to the end of the curing period which is generally 7 days or 168 hours post pour. Further, the temperature values (Temp or T) may be shown on a results display page or printed with color variations associated with the various concrete temperatures. Alternatively or additionally, the different temperature values may be represented by associated different markings such as various line patterns or hash marks. For illustrative purposes only, the results 80 for Run 1 are shown for 6 hours and 12 hours post pour. At time t=6:00 hrs, Temp₁ for example, may be estimated at 50° F. and T₂ may be 60° F. The predicted difference between Temp₁ and T₂ may be due to any one, or a combination of, construction design 12 or material details 14 considered by the model 10, 30 when considered with the predicted ambient conditions 76. Six hours later, at t=12:00 hrs, T₃ as represented in FIG. 4 is the same area of Temp₁ and T₄ is the same area represented by T₂ may show temperature values of T₃=50° F. and T₄=45° F. At later time points, the model 30 may predict that the concrete temperature will decrease to the 20s or teens in degrees Fahrenheit. The results 80 may also include information on the estimated time required to elapse in order to reach initial set and final set concrete conditions and/or may provide an estimated value for compressive strength once the cure is complete, or information on compressive strength development with time. Given what the user, Designer or Engineer may know about the relationship between curing temperature and compressive strength as shown in Table 1, the user may elect to return to the GUI 55 and select options for the model 30 to consider use of insulation or supplemental heat. This decision point is represented by step 44 of FIG. 2.

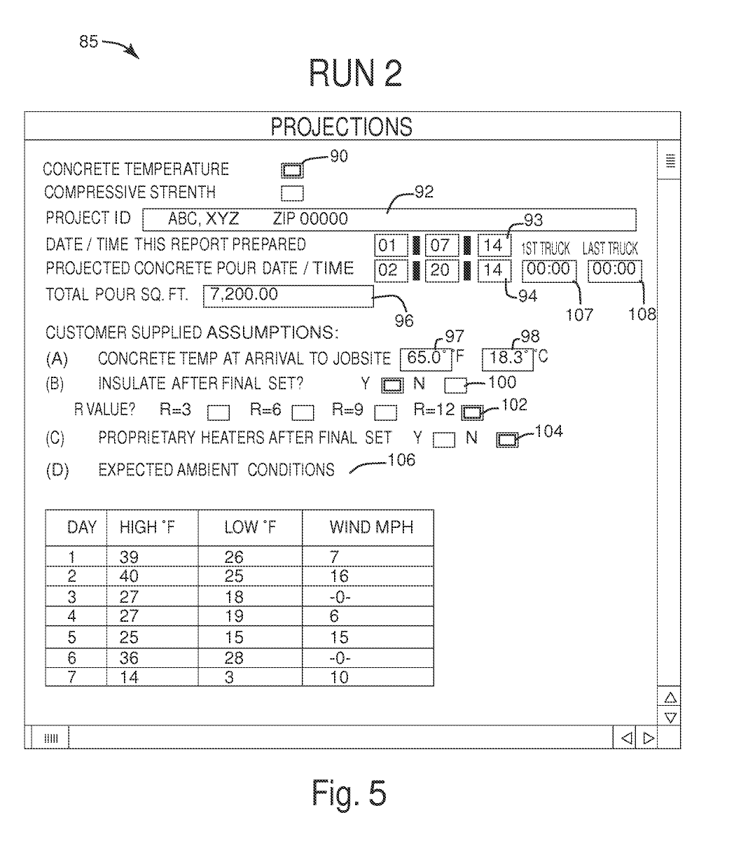

For illustration purposes only, the user in the case of Run 1 may decide to return to the GUI 55 and re-enter details related to the pour. The GUI 85 for example Run 2 is represented in FIG. 5. For Run 2, the user has not changed the input for (1) running the model 30 to predict concrete temperature 90 during the curing period, (2) project ID 92, (3) date of report 93, (4) projected pour date/time 94, (5) area of pour 96, (6) concrete arrival temperature 97, 98 and (7) no use of supplementary heat 104. However, the Run 2 example includes the planned use of insulation 100 with an R value rating of R=12 at 102. Thermal results for Run 2 (not shown) may show an improvement in curing temperature, for example, but may not indicate that concrete temperatures are maintained in a desired range. In that case, the user may again return to the GUI 85 and change the entered parameters.

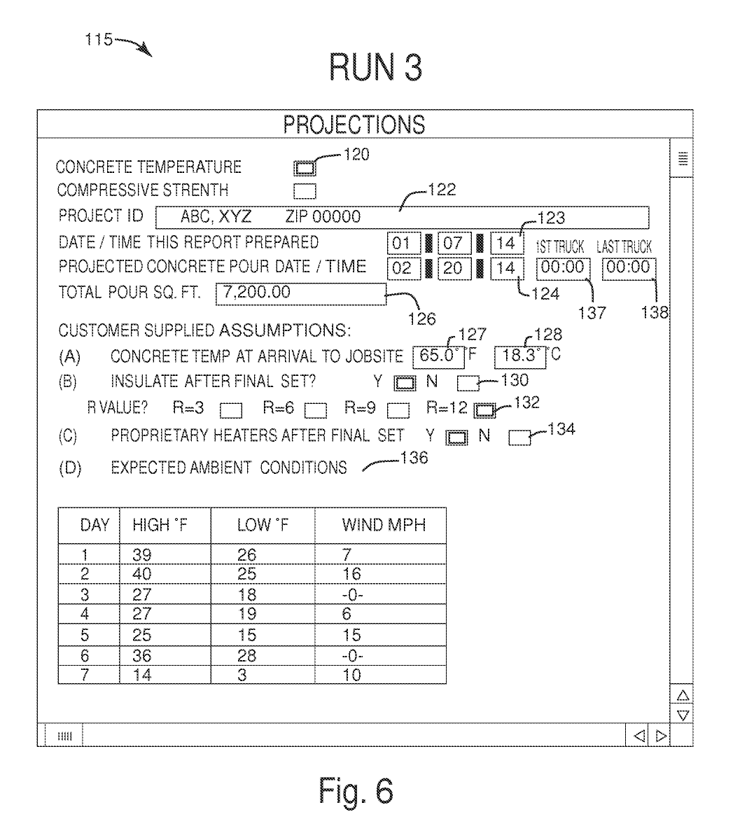

Referring to FIG. 6, example Run 3 includes GUI 115 entries that are identical to those for Run 2 for (1) running the model 30 to predict concrete temperature 120 during the curing period, (2) project ID 122, (3) date of report 123, (4) projected pour date/time 124, (5) area of pour 126, (6) concrete arrival temperature 127, 128 and (7) use of insulation 132 with R value of R=12 at 132. However, for the Run 3, the user has indicated planned use of supplemental heating 134. When supplemental heating is selected in the GUI 115, additional parameters may be entered by the user, such as preheat temperature or for the heat transfer fluid or thermostat setting for the boiler.

Once the user elects to run the model 30 to include the use of supplemental heating, the information displayed as at least part of the results may include recommended layout of equipment to be used in the supplemental or hydronic heating process, the placement of sensors such as, but not limited to, temperature sensors. The equipment layout recommendations can be given in addition to the estimated temperature results over time as shown in FIG. 4 and provided on the same screen, display or printed material as the estimated temperature results. Alternatively, the equipment arrangement layout may be provided on separate views, pages, displays or printouts from the estimated temperature results.

In extremely cold conditions, the model may indicate freezing of the concrete before reaching final set. In some instances, top down heating involving the placement of heat transfer hoses may not avoid freezing in some areas of a slab. The model 30 may suggest alternative approaches to those described above. Some examples of suggestions the logic of the model 30 may provide include the following:

i) Use of supplemental heating such as the top down heating described above.

ii) Consider modification of concrete mix formulation to accelerate the time to initial set and final set so that top down supplemental heating may be effectively implemented.

iii) Consider utilizing supplemental heat including embedded heat transfer hoses. Several advantages may be realized by the addition of embedded heat transfer hoses, including an earlier initiation of heating. However, the design team may need to make changes to off-set the concrete displaced by the hoses.

iv) Both ii) and iii), above.

v) Consider building a temporary enclosure around the structure and heat the structure with hot air.

vi) Consider undertaking the concrete pour when ambient conditions are more favorable.

For heating applications related to ground thawing rather than to concrete curing, spacing of the heat transfer hoses is important as well. Soil with large amounts of clay and/or silt may contain a higher percentage of ice than ground with larger amounts of sand and gravel. Hose spacing for ground with a lot of gravel or sand may be wider than spacing that is recommended for ground with higher clay and silt levels. Choosing the proper hose spacing for concrete curing is more complicated than selecting spacing for ground thawing projects. The difficulty is increased when the concrete is to be cured for elevated slabs. Several heat sinks may be contained in, or in close proximity to, the elevated slabs such as I-beams and steel columns. The thermal model 30 described herein, among other things, takes into account the location and/or type heat sink present in, or in close proximity to, the concrete and will recommend a layout or arrangement of heat transfer hoses, temperature sensors and other equipment based on this information.

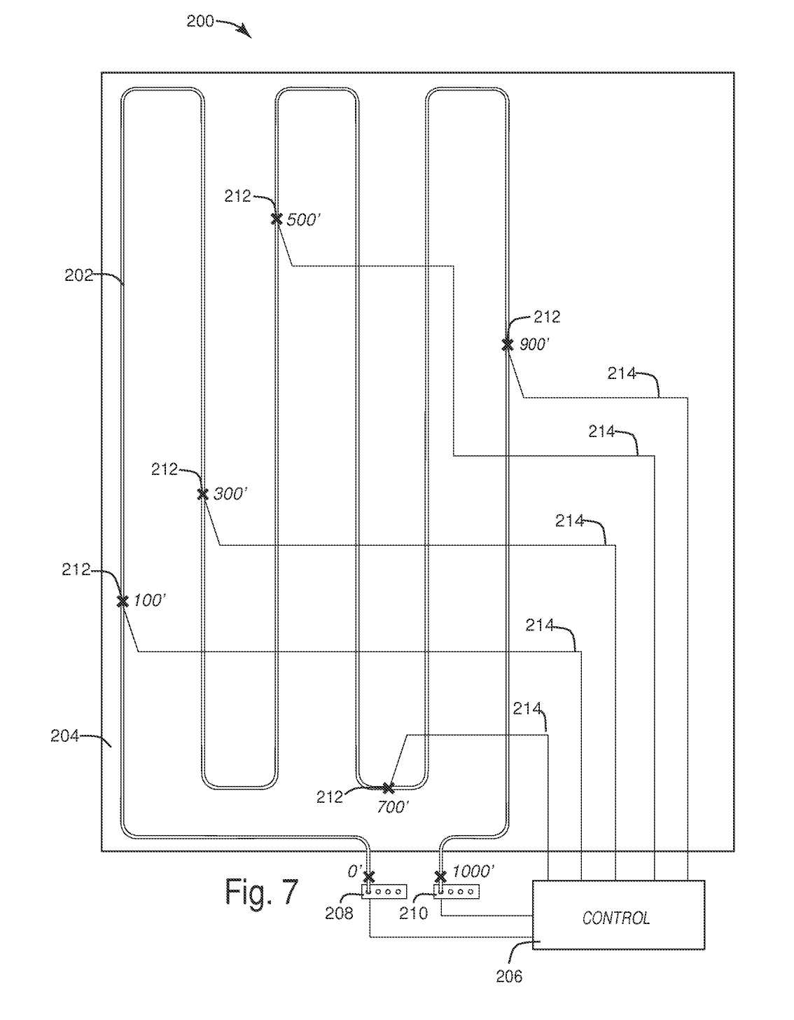

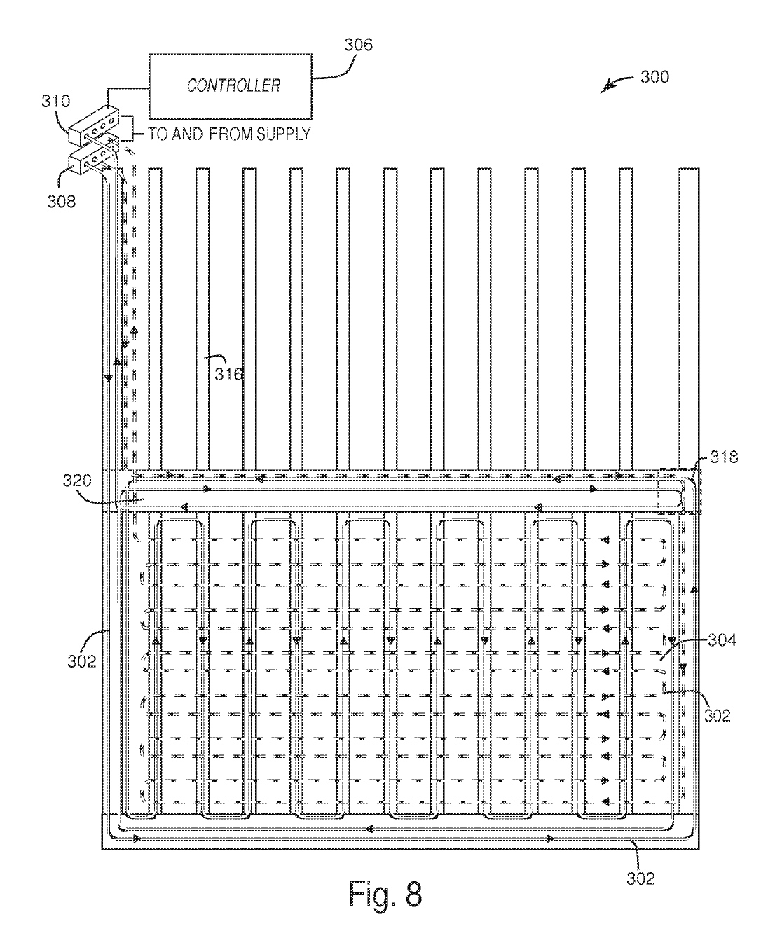

Turning to FIGS. 7 and 8, the recommended equipment layout 200 shown in FIG. 7 may include suggested locations of heat transfer hoses (“HTH”) 202 over the concrete slab 204 to be cured. In addition to the location for the HTH 202, the model 30 may suggest locations along the HTH 202 at which temperature sensors 212 are to be embedded in the concrete slab 204. The temperature sensors 212 may be in communication with a control system 206 that, in part, can monitor the temperature of the concrete slab 204 and control the direction and flow volume of heated fluid inside the HTHs 202 and through the manifolds 208, 210 discussed in more detail later. Communication from the sensors 212 to the controller 206 may be by wires 214 or wireless as by radio signal or other known means. The model 30 run results shown in FIG. 7 include equipment layout suggestion including a 1000-foot HTH 202 along which temperature sensors 212 have been embedded in the concrete slab 204 at distances from the first manifold 208 of 100 feet, 300 feet, 500 feet, 700 feet and 900 feet. While the illustrated example includes the use of a HTH 202 that is 1000 feet in length, it should be understood that hose length may vary and can impact heat transfer characteristics. A shorter heat transfer hose will circulate the heat transfer fluid for a potentially shorter period of time depending on flow rate through the hose. It is possible that the fluid will circulate through the heater faster with a shorter heat transfer hose allowing the fluid to remain at a higher average temperature.

The equipment layout 300 of FIG. 8 may be shown in addition to or alternatively from that of FIG. 7. The layout 300 of FIG. 8 includes HTHs 302 recommended to be more densely located over the 12-inch I-beams 316, the steel column 318 and 36-inch I-beam 320 supporting the concrete slab 304. The manifolds 308, 310 are in communication with the controller 306 to control the flow volume and direction of the heat transfer fluid through the HTHs 302 and to and from the fluid supply vessel (not shown).

### Heating Apparatus

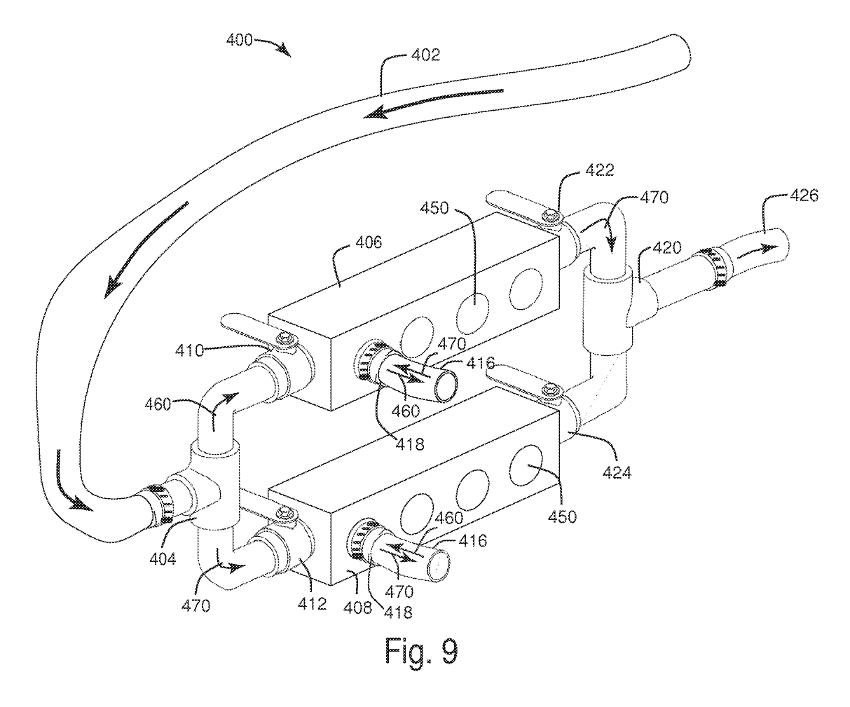

Referring to FIG. 9, a portion of a heating apparatus 400 is shown generally. A supply line 402 carries a flow of heat transfer fluid that is pumped from a supply vessel (not shown in FIG. 9) to a first plumbing assembly 404 through a connection such as a quick connect port. The plumbing assembly 404 may be any series or configuration of elbows, nipples, “T's” or “S” fittings, etc. as are used in typical plumbing applications. The plumbing assembly 404 provides a connection from the supply hose 402 to a top manifold 406 and a bottom manifold 408 through valves 410 and 412, respectively. The top manifold 406 is in communication with the inlet end 414 of a plurality of heat transfer hoses 416 (for simplicity, only the ends of one heat transfer hose is shown in FIG. 9). The bottom manifold 408 is in communication with the outlet 418 end of the heat transfer hoses 416. A second plumbing assembly 420 is in communication with the manifolds 406, 408 on an opposite end of the manifolds 406, 408 from the first plumbing assembly 404 through valves 422, 424. The second plumbing assembly 420 may be configured similarly to the first plumbing assembly 404 with components including, but not limited to, elbows, nipples, “T's” or “S” fittings, etc. The second plumbing assembly 420 is also in communication with a return line 426 through a connection. The return line 426 provides a complete circuit for the hot fluid back to the supply vessel (not shown).

In operation, the heating apparatus 400 may be configured for fluid flow through the heat transfer hose 416 in a forward direction as indicated by arrow 460 or in a reverse direction as indicated by arrow 470. As fluid is driven through the apparatus 400 in the forward direction 460, valves 410 and 424 are in an open position while valves 412 and 422 are in a closed position. The hot fluid is pumped from the supply vessel through the supply line 402 and through the plumbing assembly 404 and into the upper manifold 406 through valve 410. The fluid enters the heat transfer hose 416 at the inlet end 414 and travels through the heat transfer hose 416 to the outlet end 418 and into the bottom manifold 408. The fluid returns to the supply vessel for reheating or other treatment through valve 424, plumbing fitting 420 and return line 426. In order to maintain consistent curing conditions for concrete or a consistent temperature over an area for ground thawing, it may be desirable to reverse the flow of fluid through the heat transfer hose 416.

To operate the apparatus 400 so that fluid flows in the reverse direction 470 through the heat transfer hose 416, the valves 410, 412, 422, 424 of the apparatus 400 may be manually adjusted. Alternatively, the valves may be automatically, electro-mechanically adjusted by a controller (discussed in detail below). The change in direction of flow to the reverse direction can be accompanied by a pausing or temporary stopping of the pump. The pausing or stopping of the pump prevents cavitation of the pump and allows a smoother transition to an opposite fluid flow direction. In the reverse direction, valves 410 and 424 are closed and valves 422 and 412 are open. Fluid is allowed to flow first through the supply line 402 to the lower manifold 408 through fitting 404 and valve 412. The flow continues through the heat transfer hose 416 by entering the hose 416 at the outlet end 418 and returning to the upper manifold 406 through the inlet end 414. The fluid continues through the upper manifold 406 and out the valve 422 and through the plumbing fitting 420 to the return line 426.

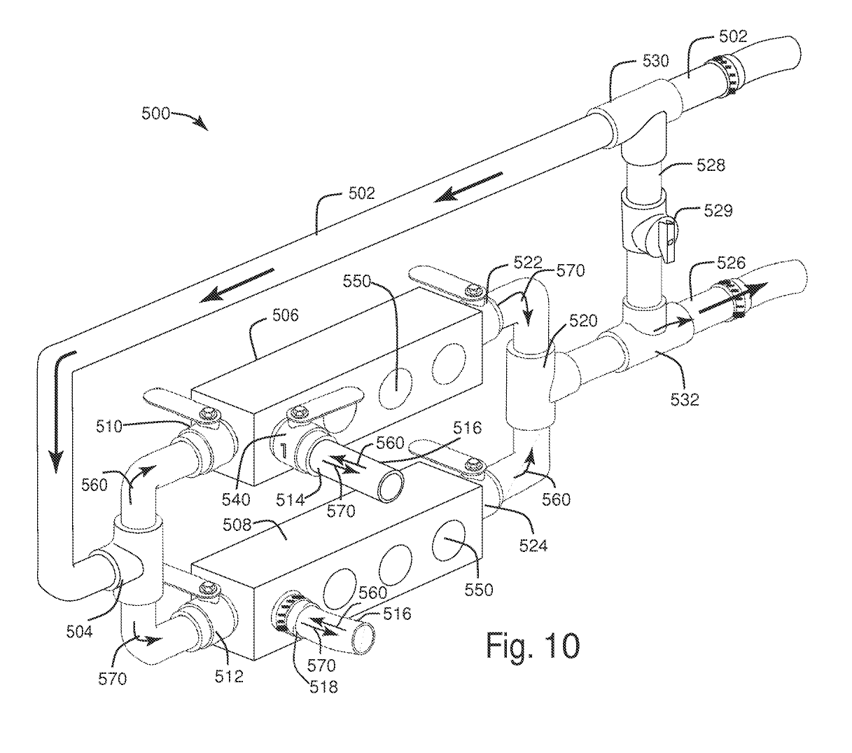

Referring now to FIG. 10, it may be desired to provide a pressure relief system between the supply line 502 and return line 526, particularly if the valves such as 510, 512, 522 and 524 are intended to provide throttling of the fluid flow through the apparatus 500. Alternatively, throttling of heat transfer fluid flow through the apparatus 500 may be achieved by adjustment of valve 540 in the upper manifold. 506. The apparatus 500 of FIG. 10 includes pressure line 528 and pressure relief valve 529 between the supply line 502 and the return line 526. Plumbing fittings 530, 532 may be fittings such as “T” fittings or other known fitting. Alternatively, the relief line 528 may connect to the supply line 502 and return line 526 by valves, such as pressure relief valve 529, rather than by fittings 530, 532. In this embodiment, the supply line 502 carries a flow of heat transfer fluid that is pumped from a supply vessel (not shown in FIG. 10) in the forward direction through the supply line 502 to a first plumbing assembly 504. The plumbing assembly 504 may be any series or configuration of elbows, nipples, “T's” or “S” fittings, etc. as are used in typical plumbing applications. The plumbing assembly 504 provides a connection from the supply line 502 to a top manifold 506 and a bottom manifold 508 through valves 510 and 512, respectively. The top manifold 506 is in communication with the inlet end 514 of a plurality of heat transfer hoses 516 (for simplicity the ends of one heat transfer hose are depicted in FIG. 10). The bottom manifold 508 is in communication with the outlet 518 end of the heat transfer hoses 516. A second plumbing assembly 520 is in communication with the manifolds 506, 508 on an opposite end of the manifolds 506, 508 from the first plumbing assembly 504 through valves 522, 524. The second plumbing assembly 520 may be configured similarly to the first plumbing assembly 504 with components including, but not limited to, elbows, nipples, “T's” or “S” fittings, etc. The second plumbing assembly 520 is also in communication with a return line 526 through a connection. The return line 526 provides a complete circuit for the hot fluid back to the supply vessel. The valves 510, 512, 522, 524 are capable of being configured to allow the heat transfer fluid to flow through the heat transfer hose 516 in a forward direction as indicated by arrow 560 or in a reverse direction as indicated by arrow 570.

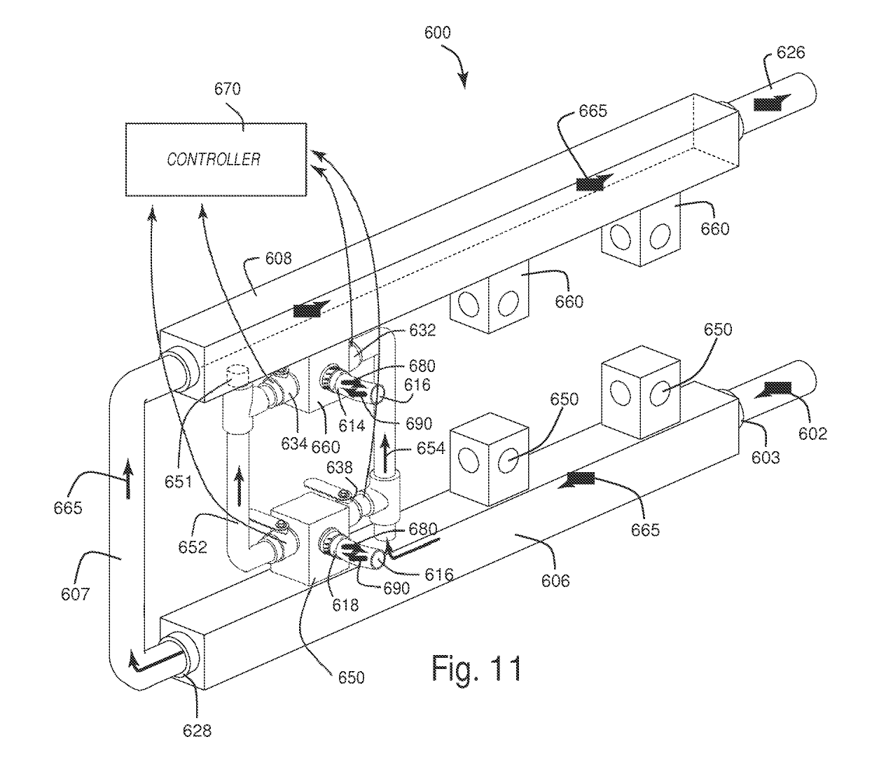

It may further be desired to control the volume of flow or flow direction in each heat transfer hose individually. Use of a controller 670 (described later in detail) to manage the flow direction, volume, velocity, etc. through individual HTHs may be provided as shown relative to FIGS. 7, 8, 11-13. The heating apparatus 600 of FIG. 11 includes a supply line 602 that carries the heat transfer fluid from a supply vessel to a first manifold 606 through a connector 603. The manifold 606 is in communication with one or more heat transfer chambers 650. For simplicity, three heat transfer chambers 650, 660 are shown on each manifold 606, 608 in FIG. 11. However, generally two or four chambers 650, 660 may be provided per manifold, but the apparatus 600 may be configured with any number of such chambers 650, 660 on the manifolds 606, 608. From the first manifold 606, the fluid enters a first plumbing assembly 654 and with a heat transfer chamber 660 in the upper manifold 608. Because valve 638 is closed, open valve 632, such as a two-port valve, for example, controls the flow of heat transfer fluid from the plumbing assembly 654 to the heat transfer chamber 660. When the apparatus 600 is set to allow fluid flow in a forward direction as indicated by arrow 680 through a particular heat transfer hose such as heat transfer hose 616, the fluid exits the chamber 660 through a coupling such as a quick connect. Valve 634 is closed allowing fluid to continue toward the first end 614 of the HTH 616. The HTH may be connected to the heat transfer chamber 660 by a quick connect coupling. If no HTH 616 happens to be connected to the heat transfer chamber 660, the quick connect coupling may serve as an automatic shut-off of fluid flow. The heat transfer fluid continues through the HTH 616, when present, and exits through the second end 618 into a chamber 650. In a forward flow direction, valve 638 is closed so that the fluid may enter a second plumbing assembly 652 through open valve 636 and continue to the upper manifold 608 through connection 651 because, as stated above, valve 634 is closed. The flow of fluid through the manifolds 606, 608 is maintained in a constant direction as indicated by arrows 665. The manifolds 606, 608 are in fluid communication through an inter-manifold plumbing assembly 607. A valve 628, such as but not limited to a pressure relief valve, may facilitate control of fluid from the lower manifold 606 through the plumbing assembly 607 to the upper manifold 608. The upper manifold 608 is in communication with a return line 626 that allows the fluid to return to the supply vessel and temperature adjusting processes such as a boiler or other known devices.

To reverse flow of fluid through the HTH 616 as indicated by arrow 690, valve 632 is closed and valve 638 is opened and valve 636 is closed so that the fluid enters the first plumbing assembly 654 and flows into the chamber 650 through valve 638. The fluid then enters the HTH 616 at the second end 618 and travels the entire length of the HTH 616 to the first end 614. At the first end 614 the fluid enters the chamber 660 and because valve 632 is closed the fluid returns to the upper manifold 608 through the open valve 634 and connection 651.

In addition to facilitating flow reversal, valves 632, 634, 636, 638 may be partially opened or closed from a full, or 100%, open setting to accomplish throttling of the fluid flow through the valves and, consequently, through the HTH 616.

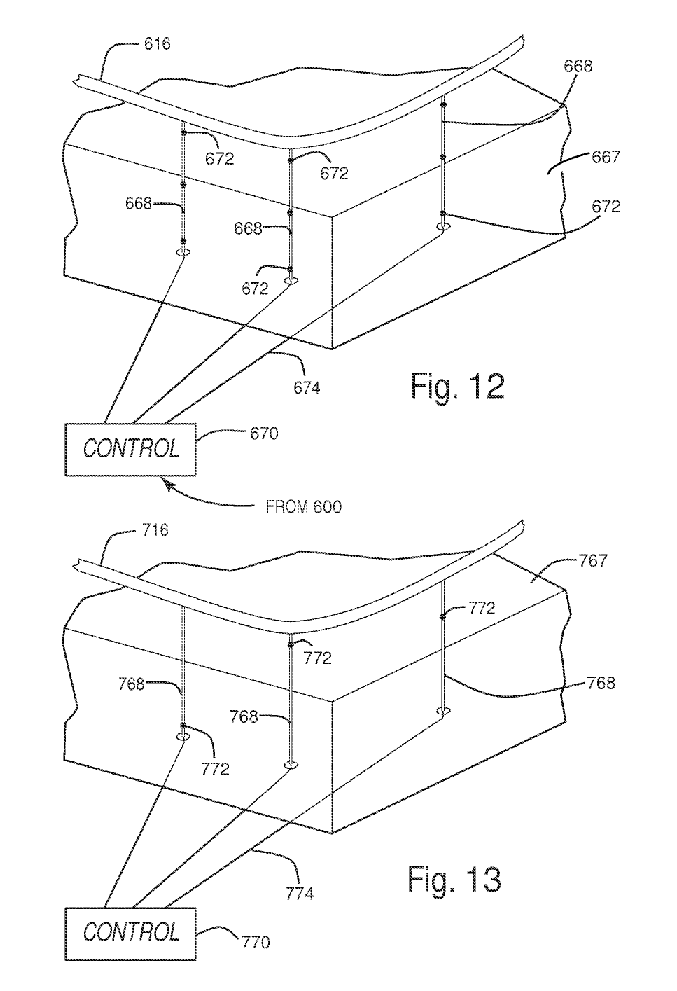

Referring now to FIGS. 12 and 13, each heat transfer hose 616, 716 may be positioned over a concrete slab 667, 767 at a location wherein a stalk 668, 768 or a plurality of stalks 668, 768 have been embedded in the concrete slab 667, 767. The location of the stalks 668, 768 and sensors 672, 772 within the slab 667, 767 may be determined by the model 30 described with respect to temperature sensors 212 of FIG. 7. Each stalk 668, 768 supports at least one sensor, such as a temperature sensor 672, 772, or a plurality of such sensors. The stalks 668 of FIG. 12 each support three sensors 672. On each stalk 668 a sensor 672 is positioned near the top, middle and bottom of the thickness of the slab 667. Each sensor 672 communicates data, such as temperature, to the controller 670. The data may be communicated by wired communication 674 or by wireless communication. Alternatively, as shown in FIG. 13, each embedded stalk 768 may support fewer than three sensors 772 in any or a combination of positions that are near the top, middle or bottom of the thickness of the concrete slab 767.

The temperature sensors 212, 672, 772 may be embedded in the slab 204, 667, 767 by pushing the stalk 668, 768 into a newly placed concrete slab 204, 667, 767. The stalks 668, 768 may be non-thermal conducting (i.e. plastic, fiberglass) small diameter rods such as, but not limited to, those having a diameter of about % inch to 3/16 inch. In the example that includes the pouring and curing of a six-inch thick concrete slab, the temperature sensors 212, 672, 772 may be placed approximately one inch from the top of the slab, about half way between the top and the bottom of the slab and also about one inch from the bottom of the slab. However, the sensors may be installed within the concrete slab at any depth. Also, it is not necessary that the HTH 616, 716 be positioned directly over the embedded stalk 668, 768, rather the HTH 616, 716 may be placed elsewhere on top of the slab 667, 767 within a zone of effectiveness of the HTH 616, 716. It should be understood that a plurality of stalks 667, 767 with sensors 212, 672, 772 may be arranged in a particular array to define a heat service area or zone.

Temperature readings of the concrete slab 204, 304, 667, 767 from the embedded temperature sensors 212, 672, 772 will be reported to the controller 206, 306, 670, 770. The reporting of the temperature data to the controller 206, 306, 670, 770 may be continuous, by periodic timing, or by the controller 206, 306, 670, 770 pinging or polling a request to the sensors 212, 672, 772 for a reading. These periodic temperature readings may be useful to the contractor in a variety of ways. For example, examination of hour by hour temperature data from the sensors can confirm it is time for the contractor to begin testing the concrete strength by analysis of the test cylinders. The controller 206, 306, 670, 770 may record and store data as desired by the programmer or user.

The controller 206, 306, 670, 770 is further coupled to, and controls the degree to which valves 510, 512, 522, 524, 632, 634, 636, 638 of the heating apparatus 500, 600 are opened and closed.

Supplemental heating systems or hydronic heaters may control the amount of heat delivered to a section of ground to be thawed or to a concrete slab to be cured by at least four mechanisms. The four main factors that impact the amount of heat delivered by such systems are (1) heat transfer hose (HTH) spacing; (2) heat transfer fluid flow rate; (3) heat transfer fluid flow direction; and (4) heat transfer fluid temperature. The factor relating to the spacing and placement of the HTHs has been described herein with respect to the model and description related to FIGS. 7 and 8. The remaining three factors impacting heat delivered to ground or concrete sections will be discussed in terms of the function of the controller 206, 306, 670, 770.

Heat transfer flow rate for a ground thawing project is typically set for a full on or maximum flow rate of the heat transfer fluid through the HTHs. Varying the flow rate through the apparatus 400, 500, 600 is of little value as the object generally is to thaw ground for initiation of a construction project. However, flow rate adjustments during concrete curing procedures can be highly valuable. Such adjustments allow fine tuning of the heat (BTUs/hour for example) being delivered to the concrete. The valves 510, 512, 522, 524, 632. 634, 636, 638 of heating apparatuses 500, 600 may be completely open, throttled between completely open or completely closed, or completely closed as directed manually by a user or as directed automatically by the controller 206, 306, 670, 770.

Reversal of heat transfer fluid flow direction within the HTHs is important in ground thawing applications to evenly distribute the heat being transferred from the fluid to a section of ground in need of thawing. As the heat transfer fluid enters the HTHs the heat from the fluid starts its transfer from the fluid to the ground. Over a period of time the fluid exiting the HTH will be significantly cooler than the fluid at entry into the HTH due to the heat of the fluid having been dissipated by the time the fluid nears the end of the HTH. Reversing the direction of flow of the heat transfer fluid within the HTHs may reduce the overall time required to complete a ground thawing project by 35-40%. Reversing the direction of the flow of the heat transfer fluid within the HTHs may also reduce the amount of fuel required to complete a thawing project by 35-40%. This reduction in the required amount of fuel is due to more efficient use of the heat, and therefore fuel, as it is not “wasted” by excessively overheating the ground nearest the inlet end of a single flow directional hose loop. During concrete curing, the temperature of the concrete is related to the rate of compressive strength development in the manner described earlier. Further, the time required to reach initial and final set of the concrete may be better controlled by reversing the flow of heat transfer fluid through the HTHs during the process. The need to reverse the flow direction of fluid through the HTHs during concrete curing stem from the same heat dissipation issues related to ground thawing projects.

The temperature of the heat transfer fluid may be adjusted up or down by adjusting the boiler or similar heating system to a higher or lower thermostat setting. If it is desired to deliver more heat energy, such as BTUs, to a ground thawing or concrete curing project the increased energy can be applied by increasing the temperature of the heat transfer fluid.

In a curing operation, the controller 206, 306, 670, 770 will acknowledge the actual temperature of the slab 204, 304, 667, 767 as reported by the temperature sensors 212, 672, 772. As discussed earlier, the controller 206, 306, 670, 770 may receive temperature readings continuously, on a periodic timing basis or when it pings the sensors 212, 672, 772 for a reading. Given the temperature profile of the slab 204, 304, 667, 767 the controller 206, 306, 670, 770 will manage heat delivery to the HTHs 202, 302, 516, 616, 716 to achieve and maintain a target concrete temperature. Based on the temperature measurements received by the controller 206, 306, 670, 770 from the sensors 212, 672, 772 the controller 206, 306, 670, 770 may initiate one or more changes in the positions of the valves 510, 512, 522, 524, 632, 634, 636, 638 to open, close or throttle their position, or to effect a reverse of fluid flow through the HTHs 202, 302, 516, 616, 716. Once the controller 206, 306, 670, 770 changes are completed, the controller will monitor or may ping the sensors 212, 672, 772 for updates in temperature status for the purpose of maintaining all sections of the curing slab 204, 304, 667, 767 at the desired temperature.

For purposes of example only, assume model 30 for the 7,200 square foot slab 304 of FIG. 8 recommended the deployment of six 1000-ft HTHs 302 (two such HTHs are depicted in FIG. 8). Four of the HTHs could be attached to chambers such as chambers 650, 660 of the apparatus 600 of FIG. 11. The remaining two HTHs may be attached to two sets of similar chambers on another, separate apparatus while the unused chambers are closed from the manifolds. Alternatively, a half-sized (2 chamber per manifold) apparatus may be provided. Both apparatuses 600 could be connected to a single heat transfer fluid pump (not shown) through the supply line 602. Fluid temperatures may also be monitored at the entry of the HTH 616 and upon exit from the HTH 616. As a practical matter, the temperature of an outside wall of the HTH 616 may be monitored at the inlet end 614 and outlet end 618 of the HTH 616. Each of the six HTHs 616 is arranged over 5 stalks 668 of temperature sensors 672. As recommended by the model 30, the stalks 668 of sensors 672 are placed at distances from the inlet end 614 of the HTH 616 at 100 feet, 300 feet, 500 feet, 700 feet and 900 feet.

Within the controller 670, a processor (not shown) may be programmed for ground thawing controls or for concrete curing controls. In this example, the user would select the “cure” as opposed to the “thaw” controls. A target concrete temperature may be set at the controller 670, for example, at 73° Fahrenheit or other target temperature as the user may choose. The controller 670 will operate to achieve and maintain a report of concrete temperature from the sensors 672 at +/−3° F. from 73° F., or a range of 70-76° F.

At the start of this example, initial conditions include a thermostat setting of the boiler or heater of the heat transfer fluid of 110° F. Initial valve settings include a forward fluid flow as described earlier herein with respect to the apparatus 600 of FIG. 11 and the open valves 632, 636 for the forward flow position are fully open. The heat transfer fluid pump is initiated and flow of the heat transfer fluid commences through the apparatus 600. Temperature readings of the inlet 614 and outlet 618 ends of each HTHs 616 are reported to the controller 670. For the sake of simplicity, the example is now restricted to a single 1000-foot HTH 616. Reporting of real time concrete temperatures from at least five locations within the slab is made to the controller 670. Assume all of the at least five sensors 672 report concrete temperatures of about 35° F. before the pump was initiated to start the flow of heat transfer fluid through the apparatus 600. The logic of the processor within the controller 670 will examine the change in temperature, or ΔT, between the sensors 672 at the 100-foot location and the 900-foot location from the inlet 614 end of the HTH 616, between the 300-foot and 700-foot location and the sensor 672 at the 500-foot location is compared to the target temperature. The controller 670 also compares the temperature change between the HTH 616 at the outbound location and the inbound location. The controller 670 will initiate a change in flow direction by opening valves 634, 638 and closing valves 632, 636 when the ΔT of the 100-foot sensor 672 and the 900-foot sensor 672 reaches a prescribed value, for example 10° F. If the threshold ΔT between the 100-foot sensor and the 900-foot sensor is not reached for reversal of fluid flow direction, the controller 670 will compare the temperature values from sensors 672 from all five locations with the target concrete temperature. The controller 670 will aggressively heat the concrete by applying flow through the HTHs 616 at full capacity until a temperature close to the target temperature is reached. The controller 670 may be designed to dial down the flow through throttling valves 632, 634, 636 and/or 638 or may change the thermostat setting of the boiler or heater of the heat transfer fluid to a lower temperature. In the event that one zone is near target temperature and another zone has not yet approached target temperature, the controller 670 will throttle down flow through the open valves 632, 634, 636 and/or 638 in the zone that is associated with temperatures close to target and will not adjust the thermostat or valves associated with a zone that has not approached the target temperature. While a concrete temperature range is targeted, it is also a task of the controller 670 to achieve an overall target temperature range without locally overheating, and potentially damaging, pockets of concrete in the slab 667.

The controller 670 may be programmed toward avoiding throttle of the valves 632, 634, 636, 638 in order to keep full flow volume through the HTHs 616. Rather, flow reversal would be preferred at set ΔTs, such as between the two ends 614, 618 of the HTHs 616 exceeding a ΔT of 2-3° F., or a ΔT of 6° F. between the 100-foot sensor 672 and the 900-foot sensor 672. However, the controller 670 may throttle valves effecting flow through one HTH 616 while reversing or leaving unchanged the flow in another HTH 616 because the controller 670 may operate valve sets independently from one another. Other examples of ΔTs that may trigger a reversal of fluid flow in the HTHs include a concrete temperature reading that exceeds 76° F. or is below 70° F. once the temperature range has been achieved. In order to obtain the temperature readings for comparison, the controller 670 may be programmed to poll the sensors at a set interval of time. Alternatively, the controller may accept continuous temperature readings and continuously repeat the comparisons to determine whether and which flow parameters to change through the apparatus 600.

During reversal of flow direction, the controller may be programmed to cause the heat transfer fluid pump (not shown) to pause. However, some larger pumps may take 30-60 seconds to spool back up to speed and may require up to a triple or quadruple draw of amperes to restart. Alternatively, a diverter valve (not shown) may be installed downstream of the pump to briefly terminate fluid flow to the manifolds 606, 608 during flow direction reversal.

The apparatus 600 may be used for ground thawing projects in addition to controlling the temperature of concrete during curing. To operate as a ground thawing device, the user would select the “thaw” controls. During the thaw mode, the user may set the heat transfer fluid heater or boiler to a maximum temperature, for example between 180-190° F. The circulation pump for the heat transfer fluid and the HTH 616 both have upper operating temperature limits. Since there are no concrete temperature sensors to poll, the segments of the operating software relative to polling for concrete temperatures would be inactive. The HTHs 616 are arranged on the ground in a uniform spacing pattern. The thaw mode may also disable the flow throttling option for controlling HTH 616 flow characteristics. The HTH 616 temperature may be polled periodically and the controller 670 may initiate a reversal of flow direction when a set ΔT is achieved between the outbound and inbound ends of the HTH 616. Generally, the thawing process is complete when the pooled water on top of the ground to be thawed disappears. The disappearing of the pooled water is due to a break down in the frost barrier that allows the water to drain into the non-frozen ground below. Thaw completion may be easily confirmed by hand digging a test hole to verify the absence of residual frost.

Relative to the operation of the hydronic system, the controller 670 may record data and/or other information related to several aspects of the system such as, but not limited to: the circulation pump (pressure and flow); the pressure and flow of heat transfer fluid in each HTH; valve throttling status (100% open, 90%, 80%, . . . 0%) and history; and current inlet and outlet temperatures for each HTH.

The controller 670 may also record and store operating data that is not related to the manifolds or fluid flow in the heat transfer hoses or concrete temperature such as, but not limited to, data related to the following aspects of a site operation may be recorded and stored for later retrieval and analysis:

1. Site conditions such as ambient temperature, wind speed and direction.

2. Fuel information such as remaining fuel on board as related to gallons and/or hours of run time remaining, or fraction of tank remaining such as E (“empty”), ¼, ½, ¾, etc. Information related to seasonal fuel use may also be recorded such as the type and amount of fuel used to power a generator and a burner to heat the heat transfer fluid.

3. Generator aspects such as, but not limited to, voltage alternating current (“VAC”) output, starting battery's voltage direct current (“VDC”) status, engine oil pressure, level and remaining life.

4. Heater information such as the actual temperature of the heat transfer fluid in the heater, heater thermostat setting, heat transfer fluid outflow temperature (for example in the pipe connecting the outlet of the heater to the inlet of the circulation pump), and burner status such as verification that systems are operational and/or providing a time and date stamp when default or malfunction conditions are sensed. Such verification of systems may include heater burner, circulation pumps, identify whether and which temperature sensors failed to report data, etc. Exhaust data may also be captured and include information such as temperature; percentage of carbon monoxide (CO), carbon dioxide (CO₂) and oxygen (O₂); and particulate emissions analysis to determine whether an excessive amount of soot is present.

5. Aspects of the processor operation such as, but not limited to: (a) current, accumulated and/or average temperature data received from the sensors and/or displayed; (b) calculated compressive strength at each temperature sensor location based on accumulated temperature history; and (c) operational or ambient data, possibly over time, relative to target concrete curing temperature.

The controller 670 may also record for future evaluation, the operating adjustments made during a project the time between adjustments and time to completion. The controller may also include alarm functions to alert the user to a number of conditions that require operator intervention, such as, but not limited to, low fuel/run time; excessively low concrete temperatures that may indicate removal or relocation of insulating blankets or HTHs 616; or excessively high temperatures that may indicate malfunction or tampering. The programming of the controller may also include a “caution” or “redline” setting or alarm to alert a user when the concrete temperature falls below the temperature programmed as an alert temperature.

The controller 670 is capable of reporting all stored and real time data when polled by a user through a hardwired, or wireless method such as by smart phone, remote personal computer, tablet or other device. Additionally, the apparatus 600 may include a control panel capable of allowing the user to access any information stored by the processor/controller.

Although the controller 670 performs many tasks, it requires no programming on the part of the end user. The user selects a concrete temperature range, for example by manipulating “up/+” or “down/−,” buttons or by entering a numeric value or range on a key pad.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A fluid circulating apparatus for adjusting temperature of a material, comprising;
a fluid source including a pump and a supply line;
a supply manifold in communication with said supply line;
a return manifold in communication with a return line;
a heat transfer hose having a first end in communication with said supply manifold and a second end in communication with said return manifold; and
a controller determining a flow rate and a direction of fluid flow in said heat transfer hose.

2. The apparatus of claim 1 wherein said controller causes said pump to pause when said direction of fluid flow is changed.

3. The apparatus of claim 1 further comprising a pressure relief conduit wherein said pressure relief conduit is in communication with both said supply line and said return line and allows a constant pressure to be maintained in the apparatus during throttling of said valve.

4. A fluid circulating apparatus for adjusting temperature of a material, comprising;
a fluid source including a pump, a supply line and a return line;
a supply manifold in communication with said supply line;
a return manifold in communication with said return line;
a heat transfer hose having a first end in communication with said supply manifold and a second end in communication with said return manifold;
a supply fluid chamber in communication with said supply manifold;
a return fluid chamber in communication with said return manifold; and
a controller determining a fluid flow direction in said supply and return fluid chambers, wherein said direction may be in a forward or a reverse direction while fluid flow through said supply line and said return line remains in a constant direction.

5. The apparatus of claim 4 wherein said controller adjusts a flow rate of the fluid by throttling at least one valve in the apparatus.

6. The apparatus of claim 5 wherein said controller further comprises a processor wherein said processor accepts temperature data from a plurality of temperature sensors in the material and said controller determines said flow direction and said flow rate of the fluid in said heat transfer hose based on said temperature data over a period of time.

7. The apparatus of claim 6 wherein said processor has a program to accept and store operating data.

8. The apparatus of claim 7 wherein said operating data includes at least one of: circulation pump flow, circulation pump pressure, valve throttling status, inlet temperature of heat transfer fluid, outlet temperature of heat transfer fluid, an ambient air temperature, a wind speed, a fuel level remaining to run the apparatus, a thermostat setting, a heat transfer fluid level, a verification that a generator is operational, generator VAC, starting battery's VDC, engine oil pressure, engine oil level, engine oil remaining life, burner status, and a verification that a plurality of systems are operational.

9. The apparatus of claim 8 wherein the program provides a report when polled by a user.

10. The apparatus of claim 9 wherein said user polls said processor remotely.

11. The apparatus of claim 8 wherein said program is revised remotely.

12. A concrete curing system, comprising:
a concrete slab having structural characteristics wherein said characteristics vary within said slab, said slab having been placed during a concrete pour;
a thermal profile of said structural characteristics wherein said thermal profile provides a prediction of temperature of said structural characteristics over a period of time relative to said pour; and
a concrete temperature adjusting apparatus having an arrangement of components on said concrete slab wherein said arrangement is determined by a location of the structural characteristics and said prediction of temperature of structural characteristics over time to maintain a target temperature of said slab.

13. The system of claim 12 wherein said characteristic is a heat sink.

14. The system of claim 12 wherein said target temperature is in a range of 70 to 76 degrees Fahrenheit.

15. The system of claim 12 wherein said structural characteristics include a heat sink and said arrangement of components is denser adjacent said heat sink as compared to an area of the concrete having no heat sink.

16. A method for optimizing concrete strength, the method comprising:
identifying an area of the concrete having a structural characteristic;
providing a thermal prediction of the concrete in said area over a period of time subsequent to a pour of the concrete;
determining a concrete target temperature for the concrete during curing;
determining a type and quantity of heat transfer equipment required to maintain said concrete target temperature based on said thermal prediction;
pouring the concrete;
placing said heat transfer equipment on the concrete wherein a density of equipment is placed on the concrete according the presence of said structural characteristic;
monitoring a concrete temperature with a plurality of sensors in the concrete; and
adjusting said equipment to maintain said target temperature.

17. The method of claim 16 wherein said structural characteristic is a heat sink.

18. The method of claim 16 wherein said concrete target temperature is between 50 and 80 degrees Fahrenheit.

19. The method of claim 18 wherein said concrete target temperature is between 70 and 76 degrees Fahrenheit.
